(19) United States
(12) Patent Application Publication
(10) Pub. No.: US 2025/0010318 A1
(43) Pub. Date: Jan. 9, 2025

(54) PUMP TOP, CANISTER CLOSURE, AND LIQUID LEVEL MONITORING APPARATUS FOR LIQUID DISPENSERS

(71) Applicant: World Club Supply Corp., Orange, CA (US)

(72) Inventors: Philip D. Lowance, Dana Point, CA (US); James Z. Monninger, Melbourne, FL (US)

(73) Assignee: World Club Supply Corp., Orange, CA (US)

(21) Appl. No.: 18/219,582

(22) Filed: Jul. 7, 2023

(51) Int. Cl. B05B 11/10; B05B 11/00

(52) U.S. Cl. CPC B05B 11/1047; B05B 11/0038; A47K 5/1205

(57) ABSTRACT

A pump top for a liquid dispenser comprises a top half, a bottom half, a cylindrical cup attached to the bottom half, and a flexible insert positioned between the top and bottom halves wherein the flexible insert comprises a liquid guide formed to lie beneath a bottom surface of the top half of the pump top. An adapter ring attachable to a canister of a liquid dispenser is provided which may interface with various canister closure components. Liquid level monitoring apparatus for a liquid dispenser is also disclosed.

### FIELD OF THE INVENTION

The subject disclosure relates to apparatus for dispensing liquids, such as, for example and without limitation, lotions, hair products, skin products, massage products, hygienic products, dental products, sun care products, inhalant, food products, and more specifically and without limitation: hair shampoo, hair conditioner, hair gel, skin moisturizer, body fragrance, body wash, hand soap, shave crème, massage lotion, massage crème, massage oil, hand sanitizer gel, antibacterial skin soap, tooth paste, mouthwash, sun block, tanning oil, after sun crème, eucalyptus oil, coffee creams, coffee flavors, coffee sweeteners, mustard, ketchup, and mayonnaise.

More particularly, the disclosure relates to improved pump top, canister closure, and liquid level monitoring apparatus for a liquid dispenser.

### DESCRIPTION OF RELATED ART

Various devices for dispensing various liquids have been developed, for example, such as the liquid dispenser apparatus disclosed in U.S. Pat. No. 11,332,279, entitled “Liquid Dispenser Apparatus,” the contents of which is incorporated by reference herein in its entirety.

### SUMMARY

According to illustrative embodiments, a liquid containing canister of a liquid dispenser apparatus is provided with a window, and an LED or other illuminating device is mounted within the dispenser to illuminate the interior of the canister such that the level of the liquid therein can be seen.

According to one illustrative embodiment, the liquid dispenser may comprise a housing and a liquid dispenser, the housing and liquid dispenser being constructed such that the liquid dispenser is removably installable into the housing and pivotally mounted with respect thereto such that the dispenser is pivotable from an upright position to a selected angle with respect to the housing. The liquid dispenser may comprise a canister having an interior and a window positioned in a wall of the canister through which a liquid level within the canister can be observed. A closure assembly is removably installable into a position closing an open end of the canister to and comprises an LED positioned to illuminate the interior of the canister so as to facilitate observation through the window of the liquid level when the liquid dispenser is positioned at the selected acute angle with respect to the housing.

In one illustrative embodiment, the window is positioned in a rear surface of the canister such that it is concealed from view when the liquid dispenser is in the upright position, although the window could be located in other positions such as on a side of the canister in other embodiments.

In various embodiments, the closure assembly may comprise any one or more of: (1) a tilt sensor configured to provide a signal to cause the LED to turn on in response to the liquid dispenser being pivoted from the upright position to the selected acute angle, (2) a magnetic field sensor configured to detect removal of the closure assembly from its installed position, (3) a timer circuit for controlling the period of illumination of the LED, and/or (4) one or more batteries for providing power to various components.

According to a second illustrative embodiment, apparatus for closing an open end of a canister of a liquid dispenser is provided, the canister having a window in a side surface thereof. In one embodiment, the apparatus may comprise an upper closure component having a bottom edge which fits flush against a lower top surface of a lower closure component. An alignment disc is positioned within an interior of the upper closure component and attached to the upper closure component. The alignment disc is configured to properly position and align a printed circuit board (PCB) located beneath it, which PCB is also shaped to fit within the interior of the upper closure component and mounts an LED, which is positioned to illuminate the interior of the canister so as to facilitate observation through the canister window of a liquid level within the canister. The lower closure component is attached to the adapter ring so as to clamp, sandwich or otherwise fix the PCB in position between the alignment disc and the lower closure component.

According to another aspect of the disclosure, an adapter ring configured to press-fit into the open end of the canister may be provided, the adapter ring and a lower closure component being configured such that the lower closure component is removably installable into the adapter ring such that the lower closure component and adapter ring are attached together with the lower closure component being fixed in a pre-determined position with respect to the adapter ring. In one embodiment, the adapter ring may be permanently fixed in the adapter ring. Closure components of various configurations may be adapted to removably attach to the adapter ring in various embodiments.

In one embodiment, the lower closure component may have a first plurality of male ridges formed on a circular exterior side surface thereof and the adapter ring configured to have a second plurality of male ridges positioned on a circular exterior side surface thereof which are configured to mate with the first plurality of ridges so as to fix the lower closure in a pre-determined position with respect to the adapter ring. The lower closure and adapter ring could be configured to attach together in other manners in other embodiments, for example, by conventional helical threads. In other embodiments, the adapter ring may be omitted, and the lower closure component threaded directly into or otherwise attached to the canister.

According to illustrative embodiments, an adapter ring may have a magnet mounted thereon, and the PCB of the second illustrative embodiment may include a Hall Effect or other magnetic sensor configured to prevent the LED from being illuminated if the adapter ring and lower closure component are not in a pre-determined aligned position with respect to one another. In various embodiments, the closure assembly may further comprise a ring having a central opening therein sized to pass a pump and a plurality of circularly arrayed fingers on an underside thereof for use in attaching the pump to the closure assembly. In other embodiments, the closure assembly may comprise a ring having a threaded circular interior and four threaded screw holes formed in respective flanges positioned ninety degrees apart around the outer perimeter of the ring and a liquid pump threadable into the threaded interior of the ring. Such pump attachment embodiments may be applied to various other dispenser embodiments other than those specifically disclosed herein.

In various implementations of the second embodiment, the PCB may mount any one or more of: (1) a tilt sensor configured to provide a signal to cause the LED to turn on in response to the liquid dispenser being pivoted from an upright position to a selected acute angle, (2) a magnetic field sensor configured to detect disconnection of the closure assembly from the adapter ring, (3) a timer circuit for controlling the period of illumination of the LED, and/or (4) one or more batteries for providing power to various components.

According to illustrative embodiments, the lower closure component may be formed of a material which passes the light from the LED so as to facilitate illumination of the liquid contents of the canister or alternatively may include a window or an opening to pass such illumination.

According to other illustrative embodiments, a pump top for a liquid dispenser is provided comprising a top component, a cylindrical bottom component, and an intermediate component positioned between the top and bottom components. The intermediate component may comprise a main body having a semi-cylindrical rear portion, an interior fluid flow channel, and a cover component which mates flush with a top surface of the main body and which is fastened in place to cover the interior fluid flow channel.

In illustrative embodiments, the top component of the pump top may comprise first and second bosses located on the underside thereof and positioned to pass through respective openings in the intermediate component which are configured to receive first and second guide pins. In one embodiment, the cylindrical bottom component has a ridged lip at the upper edge thereof which is configured to snap-fit together with one or more ridges formed on the intermediate component in order to attach the intermediate and bottom components together. In one embodiment, the top and bottom components may be so shaped and dimensioned that respective circular side surfaces of the top and bottom components meet together so as to conceal the semi-cylindrical rear portion of the intermediate component. The top and bottom components could of course be configured to attach together in different manners in different embodiments and need not provide such concealment in alternate embodiments.

A second illustrative pump top embodiment is further provided comprising a top half, a bottom half, a flexible insert positioned between the top and bottom halves, and a cylindrical cup attached to an underside of the bottom half. In one illustrative embodiment, the flexible insert comprises a liquid guide formed to lie beneath a bottom surface of the top half of the pump, the liquid guide being formed by an inner vertical side surface and an outer vertical side surface. The liquid guide is configured to conduct liquid to be dispensed from a liquid inlet port formed in the flexible insert to a liquid outlet port formed in the flexible insert. In one illustrative embodiment, the flexible insert further comprises first and second raised flexible ridges formed around the liquid guide and configured such that, when the top and bottom halves of the pump top compress the flexible insert, the first and second raised ridges form a liquid seal around the liquid flow path provided by the liquid guide.

Various illustrative embodiments of the pump top may further include or comprise any one of, or any combination of one or more of, the following features: (a) a circular plastic protector attached to a bottom end of the cylindrical cup, (b).a respective rear perimeter of each of the top half, the bottom half, and the flexible insert being configured to follow the same semicircular contour, the contour having a radius which matches a radius of the cylindrical cup, (c) the flexible insert being sandwiched between the top half and bottom halves of the pump top and concealed from view by those two components, (d) the flexible insert being formed of silicone rubber, and/or (e) the cylindrical cup and bottom half being formed as a single cast metal part.

### DESCRIPTION OF THE DRAWINGS

FIG. 1 is a side view of a liquid dispenser apparatus according to an illustrative embodiment;

FIG. 2 is a rear perspective view of a liquid dispenser component of the apparatus of FIG. 1.

FIG. 3 is a top view of the apparatus of FIG. 1;

FIG. 4 is a partial exploded perspective view illustrating a canister, adapter ring and closure component according to an illustrative embodiment;

FIG. 5 is an exploded perspective view of the closure component of FIG. 4;

FIG. 6 is a side sectional view illustrating attachment of a lower closure component to an upper closure component according to an illustrative embodiment;

FIG. 7 is a perspective view of printed circuit board (PCB) assembly according to an illustrative embodiment;

FIG. 8 is a perspective view illustrating the underside of the lower closure component and PCB according to an illustrative embodiment;

FIG. 9 is a circuit diagram illustrating circuitry mounted on the PCB of FIG. 7 according to an illustrative embodiment;

FIG. 10 is a second circuit diagram further illustrating circuitry mounted on the PCB of FIG. 7 according to an illustrative embodiment;

FIG. 11 is a partial side sectional view illustrating a two-part shroud component;

FIG. 12 is a partial side perspective view illustrating a pump engine with attached liquid cartridge according to an illustrative embodiment;

FIG. 13 is a side perspective view of a pump top according to an illustrative embodiment;

FIG. 14 is bottom perspective view of the pump top of FIG. 13;

FIG. 15 is a top perspective exploded view of the pump top of FIG. 13,

FIG. 16 is a bottom perspective exploded view of the pump top of FIG. 13;

FIG. 17 is an exploded perspective view of an intermediate component of the pump top of FIG. 13;

FIG. 18 is a partial perspective view of the lower closure component of the illustrative embodiment;

FIGS. 19 and 20 are partial sectional views illustrating a mechanism for locking the closure in position with respect to an adapter ring component according to an illustrative embodiment;

FIG. 21 is a side sectional view illustrating the mating relationship between the lower closure and adapter ring according to the illustrative embodiment;

FIG. 22 is a partial perspective view illustrating a scalloped area formed in the lower closure component;

FIG. 23 is a partial side sectional view illustrating the components shown in FIG. 4-22 in an assembled state;

FIG. 24 is a partial perspective view of alternative structure for providing flexure in a lower closure wall;

FIG. 25 is a first exploded perspective view illustrating another pump top embodiment;

FIG. 26 is a second exploded perspective view of the embodiment of FIG. 25;

FIG. 27 is a perspective view of the pump top of FIG. 25 in an assembled state;

FIG. 28 is a top view of the pump top of FIG. 27;

FIG. 29 is a sectional view taken at XXX-XXX of FIG. 28;

FIG. 30 is a perspective view illustrating a single piece cast form of a cylindrical hub and lower pump top half according to an illustrative embodiment;

FIG. 31 is a side sectional view of the apparatus of FIG. 30;

FIG. 32 is a perspective view illustrating pump top mounting apparatus attached to a shroud/closure assembly according to an illustrative embodiment;

FIG. 33 is a perspective view of a ring component shown in FIG. 32;

FIG. 34 is a perspective view of a liquid pump mountable in the apparatus of FIG. 33; and

FIG. 35 is a perspective sectional view of the apparatus of FIG. 32.

### DETAILED DESCRIPTION OF ILLUSTRATIVE EMBODIMENTS

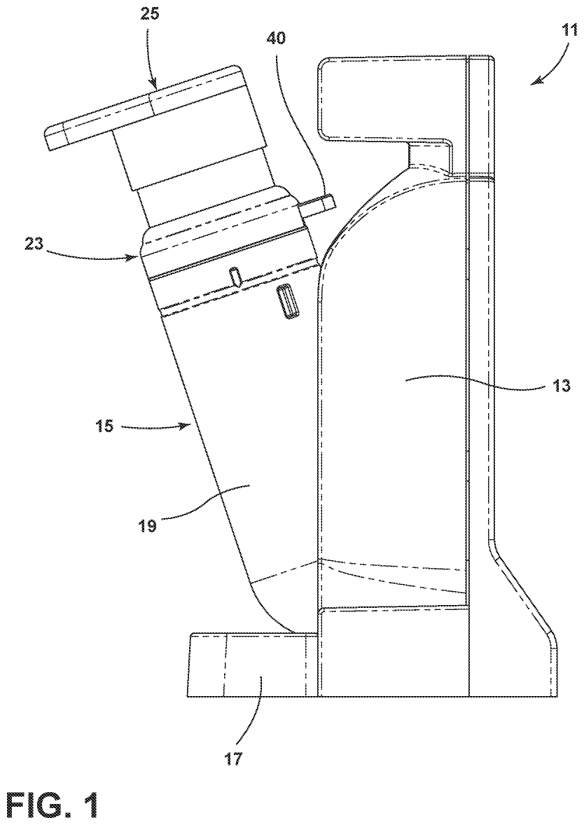

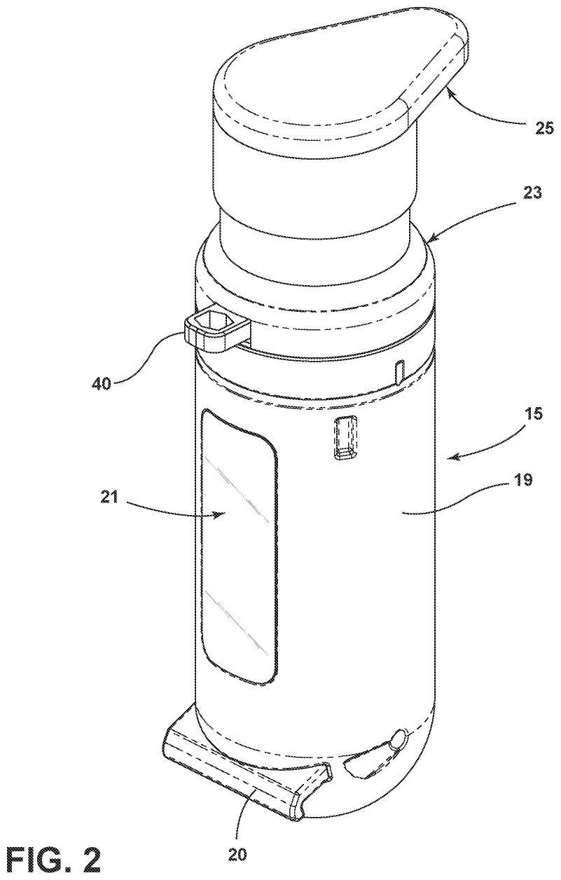

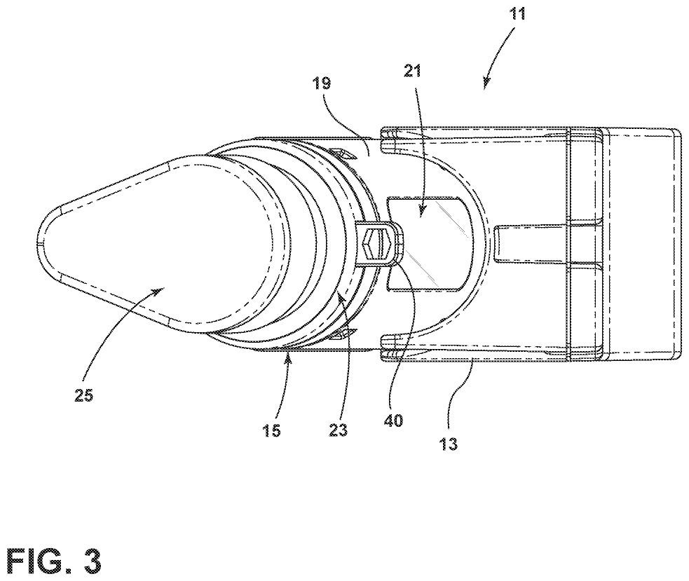

FIGS. 1-3 depict an illustrative embodiment of a liquid dispenser apparatus 11 having a housing 13, a liquid dispenser 15, and a drip tray 17. The liquid dispenser 15 includes a canister 19 having a transparent rectangular window 21 on its rear surface, through which one may view the liquid level in the dispenser 15 when the dispenser 15 is tilted to a “filling” position at an acute angle to the housing 13 as shown in FIGS. 1 and 3. FIG. 2 further illustrates a hook 20 employed in mounting the dispenser 15 to the housing 13 and a hook 40 employed in locking the dispenser 15 in an upright position in the housing 13, all as described in more detail in U.S. Pat. No. 11,332,279.

The window 21 is mounted in the canister 19 with a leak-proof seal. In an exemplary embodiment, the leak proof seal is created by a depression formed around the exterior of the window opening within which a clear plastic window 21 is mounted flush to the exterior of the canister 19. A suitable waterproof adhesive, preferably UV curing, is used between the clear plastic window perimeter and the window opening perimeter to facilitate a waterproof seal between the window surface and the canister 19. In one illustrative embodiment, the window 21 may measure approximately 1-inch wide by 3-inches high, but may have other dimensions in other embodiments. In illustrative embodiments, the housing 13 may be a molded plastic, while the canister 19 may be formed of a suitable metal. Other materials may also be used to form the housing 13, canister 19, and window 21 in other embodiments.

In one embodiment, the liquid to be dispensed may be loaded or filled directly into the canister 19, while in other embodiments, the liquid to be dispensed may be contained in a clear cartridge or plastic bag or other reservoir sealably attached to a pump (e.g. FIG. 12) and residing within the canister 19. Thus, the liquid level to be viewed through the window 21 may be either the level of a liquid filled directly into the canister 19 or the level of a liquid contained in a reservoir attached to a liquid dispensing pump.

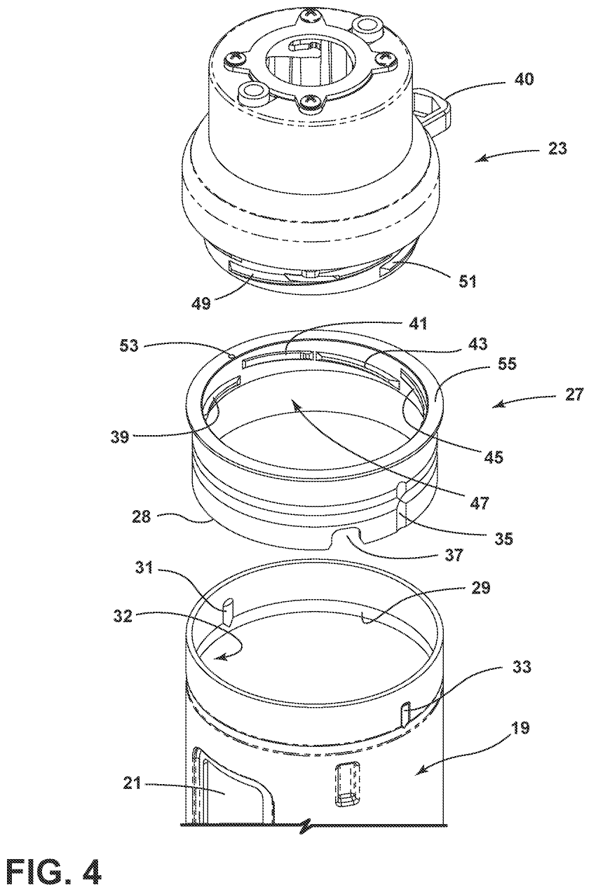

The liquid dispenser 15 of FIGS. 1-3 further includes a closure assembly 23 and a pump head 25. As illustrated in FIG. 4, the closure assembly 23 is attached to the canister 19 by a circular adapter ring or insert 27. In an illustrative embodiment, the adapter ring 27 is permanently press-fitted into the canister 19 prior to removable attachment of the closure assembly 23 thereto. In one embodiment, the adapter ring 27 is formed of a suitable plastic but could be fabricated of other materials such as metal in other embodiments. The canister 19 includes a circular interior ridge 29, which provides a waterproof seal between the installed adapter ring 27 and the canister 19.

The adapter ring 27 further includes an opening 37 on its lower circular edge 28, which mates with a projection (not shown) on the interior surface 32 of the canister 19 in order to insure proper alignment of the ring 27 with the canister 19. Vertical projections 33, 35 on the interior surface 32 of the canister 19 and seat in respective indentations, e.g. 35, on the lower exterior surface of the adapter ring 27 to further align the components. Male ridges or threads, e.g., 39, 41, 43, 45 are formed around the interior 47 of the adapter ring 27 to provide a threaded engagement with similar male ridges, e.g., 49, 51 formed on the closure 23, as will be described in further detail below

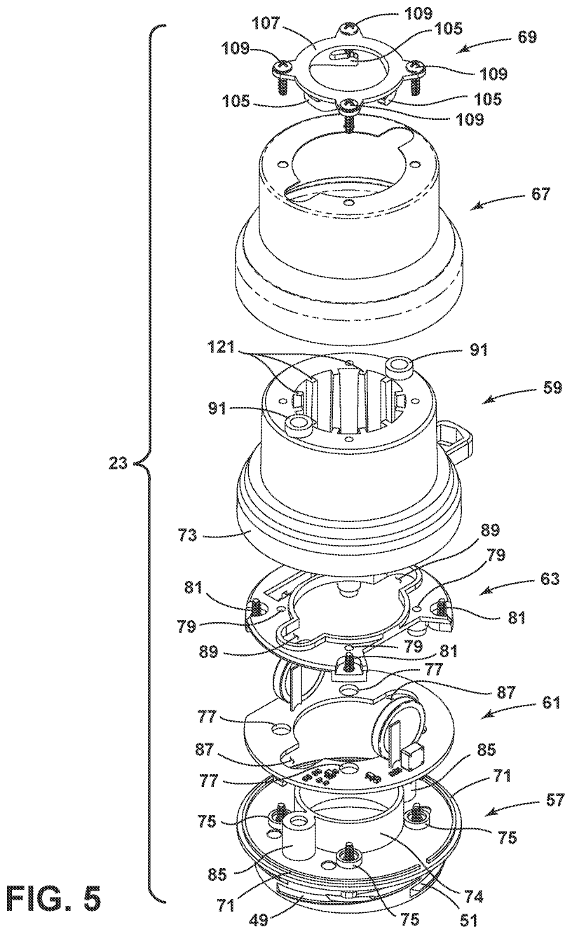

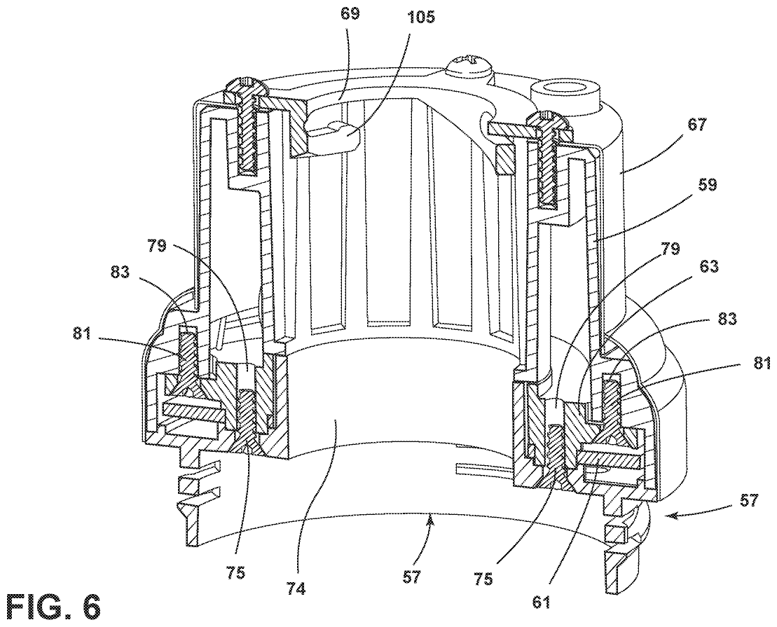

As shown in FIG. 5, in an illustrative embodiment, the closure assembly 23 includes six concentrically positioned components: a lower closure component 57, an upper closure component 59, a printed circuit board (PCB) 61, a PCB alignment and support disc 63, a shroud 67, and a pump engine engagement member 69. The lower closure component 57 has a split circular lip 71 formed on its periphery which mates with the interior of a lower flange 73 of the upper closure component 59 to position the two components and facilitate their attachment, for example, using a suitable adhesive. The lower closure component 57 further includes a central cylindrical positioning ring 74, which fits through conforming openings in the PCB 61 and PCB alignment disc 63 as further shown in FIG. 6.

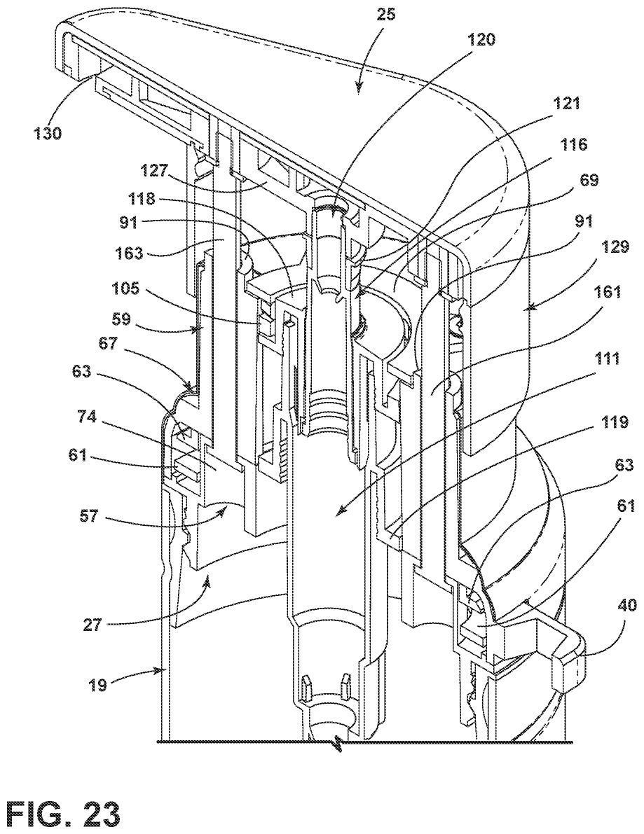

In an illustrative embodiment, as shown in FIGS. 5 and 6, attachment of the assembly components 57, 61, 63, 59 together is accomplished by first installing the PCB alignment disc 63 into the upper closure 59 by threading screws 81 through respective openings in the alignment disc 63 and into respective openings 83 in the upper closure 59. The PCB 61 is then positioned in place and held there by attaching the lower closure 57 into place by passing respective screws 75 through three respective holes 77 in the PCB 61 and threading them into three respective holes 79 in the alignment disc 63. During this assembly, first and second bosses 85 pass through respective cut-outs 87, 89 in the PCB 61 and alignment disc 63 and communicate with respective bosses 91 on the upper shroud component to facilitate passage of respective guide pins 161, 163 (FIG. 23) as further described below. Attachment of these components together may be accomplished by other means in other embodiments, for example, by use of suitable adhesives.

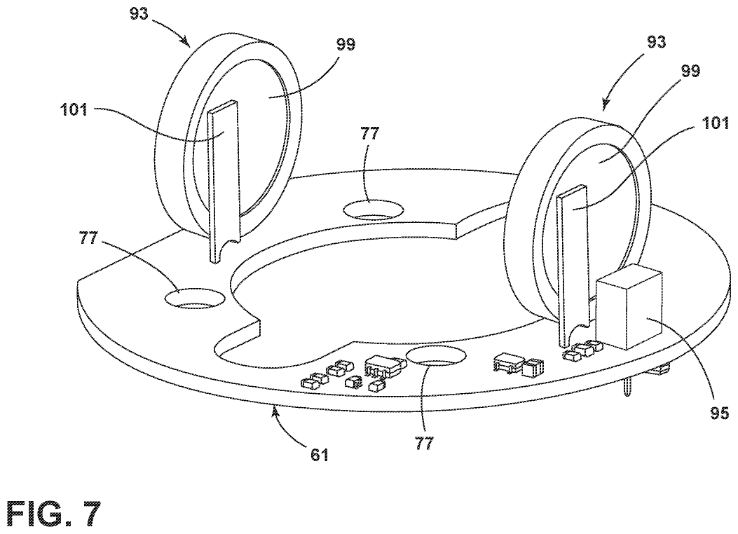

The PCB 61 and its components are illustrated in further detail in FIGS. 7-10. The components mounted on the PCB 61 include first and second battery modules 93, a rolling ball tilt sensor 95, and a Hall Effect sensor 97, as well as circuit components cooperating with them to produce output signals to cause various functions to be further described. In an illustrative embodiment, the battery modules 93 each include a disc-shaped 3-volt lithium ion or other suitable battery 99, each electrically attached to a respective conductive vertical support rod 101 attached to the PCB 61. In an illustrative embodiment, the tilt sensor 95 and Hall Effect sensor 97 may each be an off-the-shelf component, for example, such as part nos. RB 220-07A R and S17201-B-05-IVR as manufactured by C&K Switches (now part of Littlefuse, Inc.) and Silicon Laboratories, Inc, respectively.

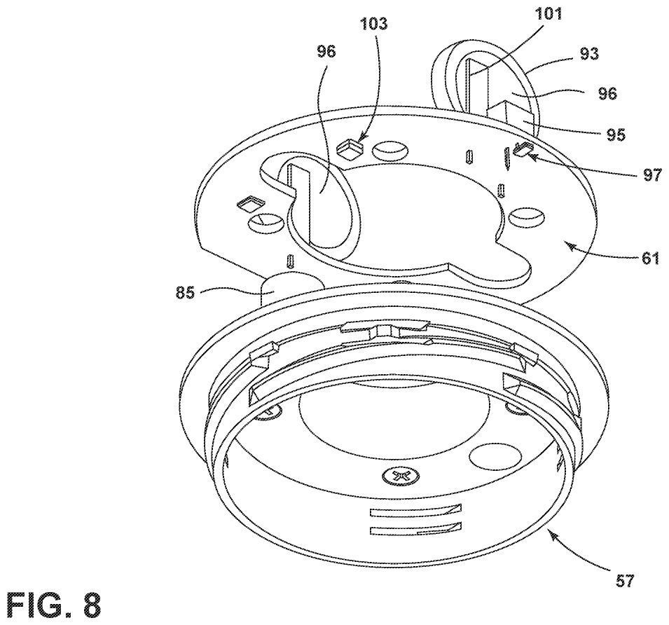

As seen in FIG. 8, an LED light source 103 is mounted on the underside of the PCB 61 and positioned to direct its light output into the canister 19 to illuminate the interior of the canister 19 so that the level of the liquid in the canister can be seen through the viewing window 27 mounted in the side of the canister 19. To facilitate this function, the lower closure component 57 may be fabricated of clear, light transparent material. Alternatively, a transparent window or an opening could be formed in the component 57 to pass the LED light.

In operation, when the canister 19 is moved to the “filling” position shown in FIGS. 1 and 3, the tilt sensor 95 detects the movement and, in response, the PCB circuitry turns on the LED so that the liquid level in the canister 19 can be clearly seen. To prevent unnecessary battery drainage, a small permanent magnet 53 is mounted on a top circular edge 55 of the adapter ring 27 (see FIG. 4) and is positioned such that it aligns with the Hall Effect sensor 97 on the PCB 61 only when the closure 23 is installed and fully seated in its correct location in the adapter ring 27. When so aligned, the Hall Effect sensor 97 enables the tilt switch 95 to operate to turn on the LED 103 only when the closure 23 is installed and fully seated in its correct location in the adapter ring 27. This functionality serves to prevent the tilt sensor 95 from turning on the LED 103 and draining battery when the closure 23 is not in the properly installed position with respect to the canister 19. This feature is particularly useful to prevent battery drainage during shipping and storage when the closure assembly could be any angular orientation. In other embodiments, the LEDs could be controlled by a manual on-off switch, but such embodiments would be subject to human error with respect to the on-off function.

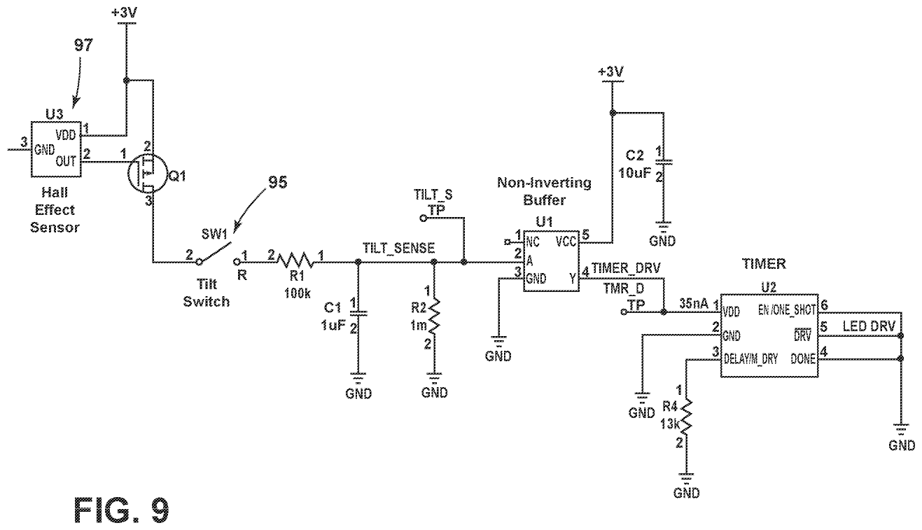

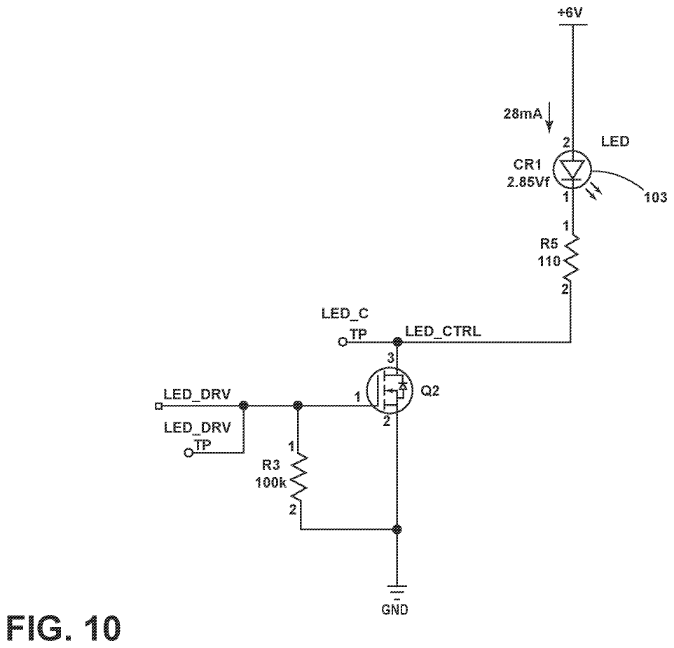

The circuitry mounted on the PCB 61 in an illustrative embodiment is illustrated further in FIGS. 9 and 10. As shown, when the Hall Effect sensor 97 senses proper alignment of the magnet 53, it outputs a signal to transistor Q1 to allow current flow through the tilt sensor 95. When the liquid dispenser 15 is tilted to the filling position, the tilt sensor switch 95 closes, supplying a tilt sense signal to a non-inverting buffer U1, which in turn provides a timer drive signal to a timer circuit U2. In response, the timer circuit U2 provides a drive signal LED DRV on its output pin 5 to the LED driver transistor Q2 of FIG. 10, which in turn provides a drive signal LED_CTRL, which illuminates the LED 103 for a selected time interval. In the illustrative embodiment, the interval is determined by the value of the resistor R4 connected to the “delay” pin of the timer circuit U2 and in an illustrative embodiment may be 15 seconds, but of course may be of different durations in different embodiments. In an illustrative embodiment, the two 3-volt lithium batteries 99 are connected in series so as to provide either the 3 or 6-volt supply voltages shown. In one embodiment, the timer circuit U2 may be part no. TPL5111DDCT as manufactured by Texas Instruments.

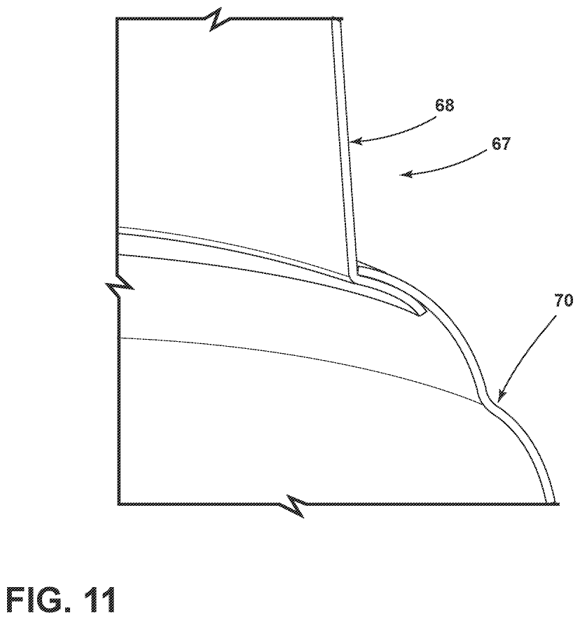

The cover (shroud) 67 shown in FIG. 5 is employed to encase the exterior of the plastic closure 59 of FIG. 5. In one embodiment, the shroud 67 may be a stamped stainless steel cover, which forms a new bearing surface on which the cylindrical metal component 129 of metal pump top 25 rides. In another embodiment, the shroud 67 may be formed as two separately deep drawn components 68, 70, as shown in FIG. 11, by, for example, polymer gluing or welding the two components together, for example, using a welding process which does not require use of additional metal. In such embodiments, the cylindrical metal pump top 25 may be coated with a material with a low coefficient of friction like PTFE (Teflon) that is highly resistant to abrasion.

The pump engagement member 69 of FIG. 5 includes three circularly arrayed pump attachment fingers 105 mounted or formed on the underside of a ring 107, which is attached to the shroud 67 and upper closure 59 via screws 109 or other suitable fastening devices. An embodiment of a cooperating pump engine 111 is shown in FIG. 12 and includes three circularly arrayed slot-like receptacles 113 arrayed about a central cylinder 118 through which the pump stem 116 and pump top opening 120 pass.

The three slot-like receptacles 113 are configured to receive and engage a respective one of the pump attachment fingers 105. In an illustrative embodiment, the end, e.g., 115 of each receptacle 113 is widened somewhat to establish a pre-load which causes the fingers 105 to snap into place. Thus, the pump engine 111 and attached refill cartridge 112 (if any) is initially installed upwardly into the pump engagement member 69 with the fingers 105 residing in the gaps, e.g., 117 between the receptacles 113. The pump engine 111 is then rotated to cause the fingers 105 to engage with the receptacles 113, thereby attaching the pump 111 to the closure assembly 23.

Other features shown in FIG. 12 include a ring 119 which interfaces with ribs, e.g. 121 (FIG. 5), formed on the interior of the upper closure 59 to provide additional stability to the pump 111 and an installation bushing 121, which limits the travel of the pump to insure proper engagement with the pump top 25.

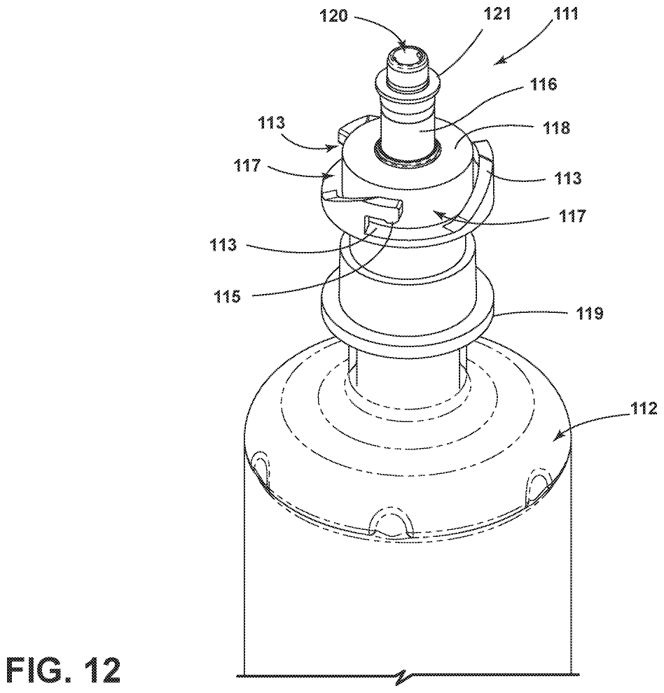

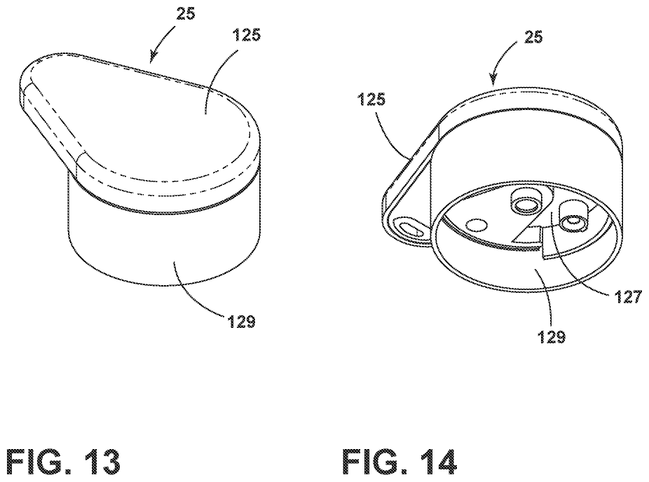

As shown in FIG. 13-17, the pump top 25 of the illustrative embodiment comprises a top component 125, a cylindrical bottom component 129 and an intermediate component 127 positioned between the top and bottom components 125, 129. In an illustrative embodiment, the top and bottom components 125, 129 are formed from a suitable metal, and the intermediate component 127 is formed from a suitable plastic. In the illustrative embodiment, the intermediate component 127 includes a main body 126 and a plastic cover component 131, which mates flush with a top surface 124 of the main body 126 of the intermediate component 127. In an illustrative embodiment, the cover component 131 is ultrasonically welded or otherwise hermetically sealed in place to create an interior fluid flow channel in the intermediate component 127 which extends from a pump stem insertion point 128 to a liquid exit point 130. The plastic intermediate component 127 also includes an over molded metal insert 132 on its lower front surface, which, in one embodiment, may be finished to match the aesthetics of the other metal parts of the top 25. In other embodiments, the metal insert 132 could be bonded in place rather than over molded.

As shown in FIG. 13-17, the pump top 25 of the illustrative embodiment comprises a top component 125, a cylindrical bottom component 129 and an intermediate component 127 positioned between the top and bottom components 125, 129. In an illustrative embodiment, the top and bottom components 125, 129 are formed from a suitable metal, and the intermediate component 127 is formed from a suitable plastic. In the illustrative embodiment, the intermediate component 127 includes a main body 126 and a plastic cover component 131, which mates flush with a top surface 124 of the main body 126 of the intermediate component 127. In an illustrative embodiment, the cover component 131 is ultrasonically welded or otherwise hermetically sealed in place to create an interior fluid flow channel in the intermediate component 127 which extends from a pump stem insertion point 128 to a liquid exit point 130. The plastic intermediate component 127 also includes an over molded metal insert 132 on its lower front surface, which, in one embodiment, may be finished to match the aesthetics of the other metal parts of the top 25. In other embodiments, the metal insert 132 could be bonded in place rather than over molded.

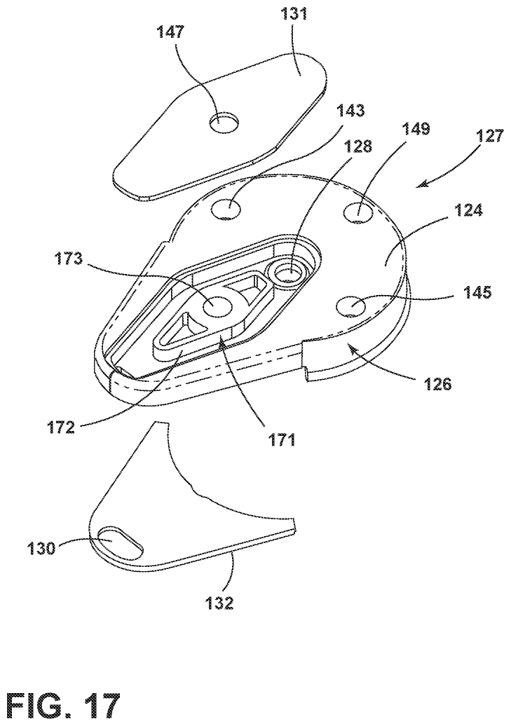

As seen in FIG. 17, the interior of the intermediate component 127 includes a liquid guide 171 formed therein, whose outer side surface 172 guides liquid from the pump stem attachment point 128 to the liquid dispensing opening 130. The liquid guide 171 includes a central opening 173, which receives the boss 135 of the top component 125 after it passes through the opening 147 in the cover component 131.

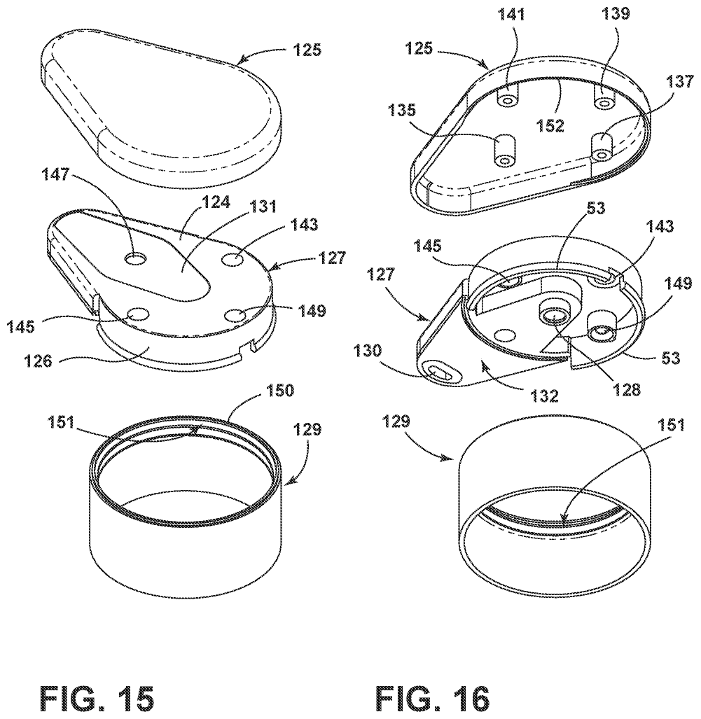

As seen in FIG. 16, the top component 125 of the pump top 25 includes two threaded bosses 139, 135 on its underside positioned to pass through respective openings 149, 147 of FIG. 15 in the intermediate component 127. First and second guide pins 161, 163 thread into these openings as shown in FIG. 23 to assist in holding the assembly together. The top component 125 further has additional threaded bosses 141, 137, formed on its underside, which mate respectively with openings 145 and 143 of FIG. 15 to further position the top component 125 with respect to the intermediate component 127.

As seen in FIG. 15, the cylindrical metal bottom component 129 has a ridged lip 151 at its upper edge, which is configured to snap-fit together with ridges 53 formed on a cylindrical rear portion of the intermediate component 127 in order to attach the two components 127, 129 together. In an illustrative embodiment, the top and bottom components 125, 129 are so shaped and dimensioned that their respective circular edges 150, 152 meet together so as to conceal the semi-cylindrical rear portion of the intermediate component 127, as shown in FIG. 13. Other means of attaching these components 125, 129 and other components of the pump top 25 together could of course be employed.

As shown in FIG. 23, the pump stem 116 and pump top opening 120 sealingly engage the opening 128 in the intermediate pump top component 127. When the pump head 25 is manually depressed, liquid is expelled into the user's hand directly from the small opening 130.

In one embodiment, the bottom component 129 may be formed of stainless steel, for example, by a stamping procedure. The top component 125 may also be formed of stainless steel with the threaded bosses welded thereto. The components 125, 127, 129, 131 may be fabricated from other materials by various procedures in other embodiments. In one embodiment, a press-fit engagement is formed between the open tip of the pump stem and the boss 128 on the intermediate component 127.

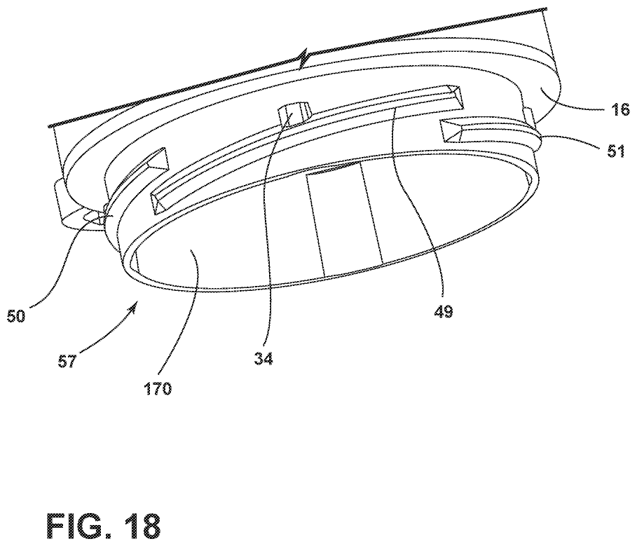

As further illustrated in FIG. 18, in one illustrative embodiment, the lower closure 57 has three male threads 49, 50, 51 located about its circumference beneath its bottom lip 16. The male threads of the lower closure 57 are configured to mate with respective male threads 39, 41, 43, 45 located on the inner surface of the adapter ring 27 (FIG. 4).

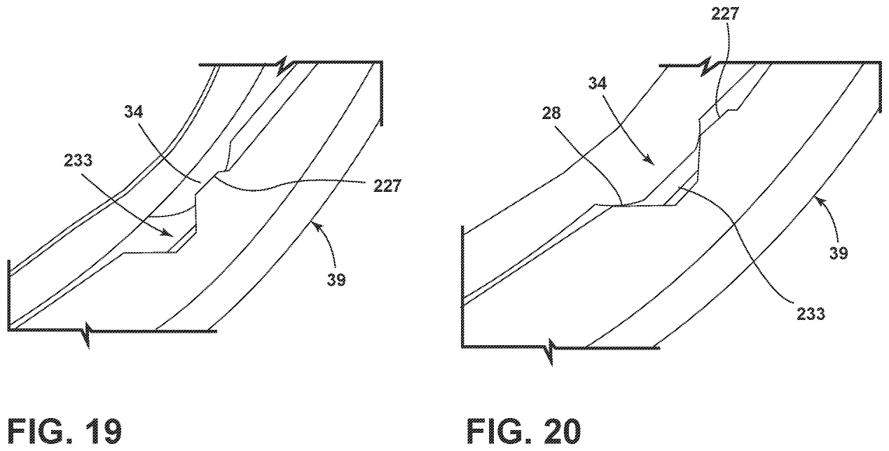

As shown in FIG. 18, each male thread 49, 50, 51 on the lower closure 57, includes a centrally positioned vertical post, e.g. 34, which serves as a locking feature. As shown in FIGS. 19-21, the adapter ring male thread 39 has a slightly projecting surface or “bump” 227 located in front of a depression or “seat” 233. As an opposing lower closure male thread travels across the adapter ring male thread 39, it experiences a slight interference and flexure with bump 227 until it pops into the seat 233. The posts 34 on the other two adapter ring male threads 43, 45 interact with similarly formed bumps and seats in their respective mating male threads to lock the lower closure 57 into position in the adapter ring 27. In other embodiments, conventional helical threads could be used on the adapter ring 27 and lower closure 57 to attach them together. However, the illustrative embodiment provides the advantage of positive locking of the components in a pre-determined position which insures proper alignment of the assembly components.

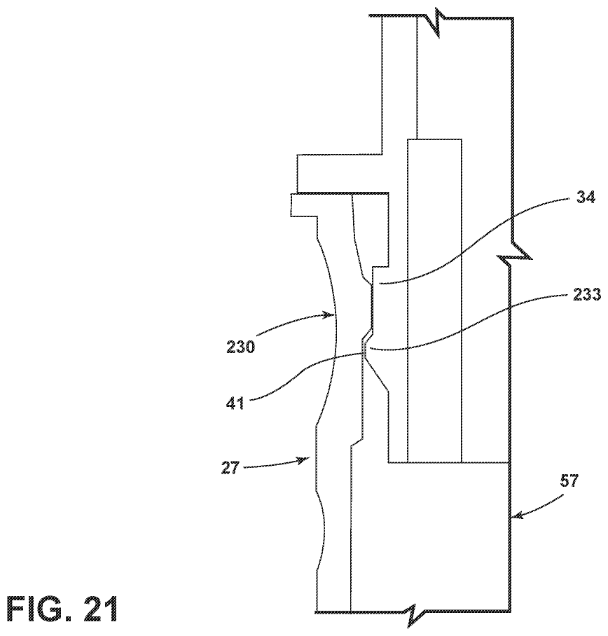

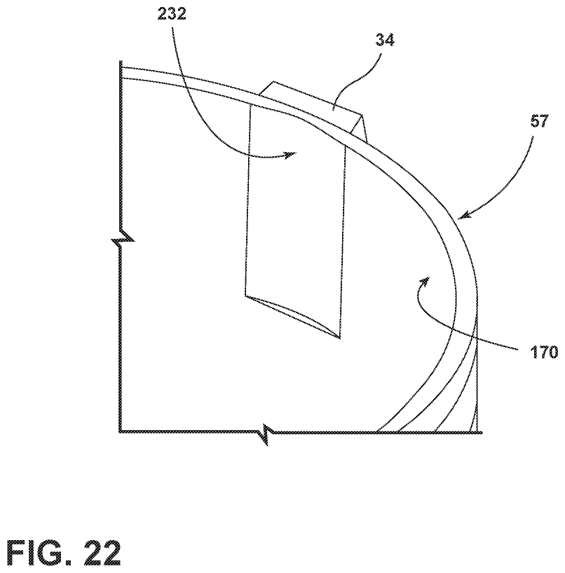

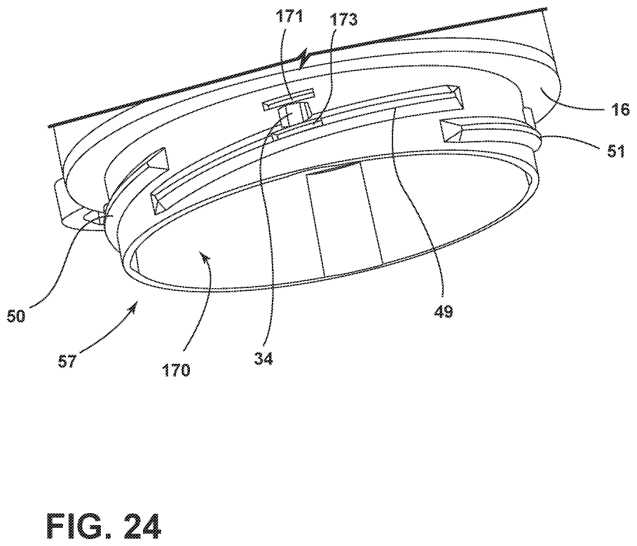

FIG. 21 further illustrates the locked position of the posts 34, as well as an inwardly scalloped side surface 230 formed in the adapter ring 27 at the post location, which facilitates flexure of the interlocking mechanism. As shown in FIG. 22, a localized scallop 232 may be formed in the inner surface 170 of the closure 57 behind a post 34 to locally reduce the closure wall thickness to, for example, 1.0 mm/0.04 inches in one embodiment, to encourage local deflection at the post location. In another embodiment shown in FIG. 24, horizontal slots 171, 173, which extend entirely through the closure side wall, are formed above and below each post 34 to provide the desired degree of inward flexure during installation. Such slots 171, 173 may prove more effective in certain embodiments and provide the additional advantage that the slot length can be extended or shortened to achieve a desired degree of flexure.

In assembly in one illustrative embodiment, the components of the closure assembly 23 as shown in FIG. 5 are assembled together into a unit, and a pump 111 such as shown in FIG. 12 is attached thereto as described above. The closure assembly 23 and attached pump 111 are then attached to the adapter ring 27, which has previously been permanently press-fit installed into the canister 19. A pump top 25 may then be attached to the stem 120 of the pump 111.

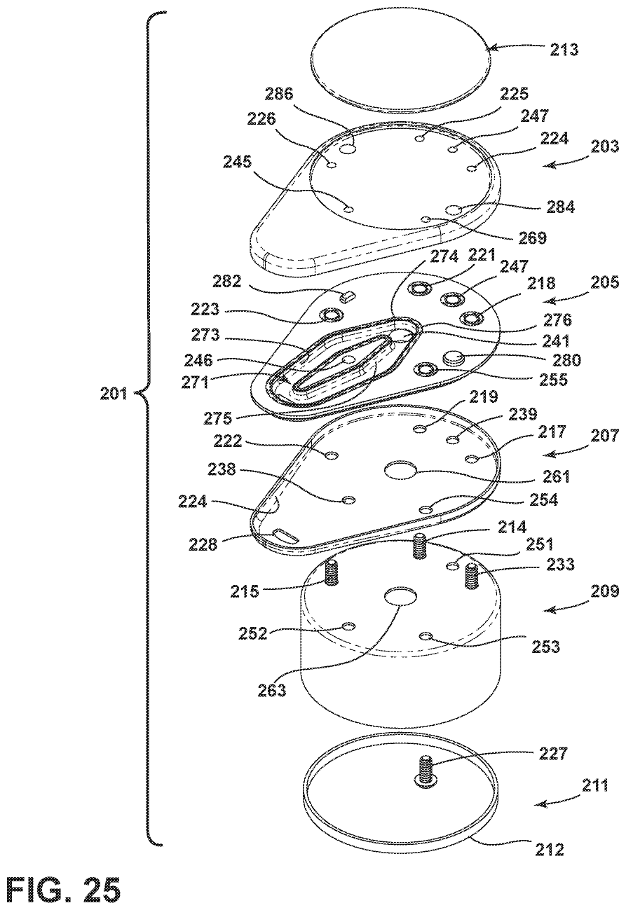

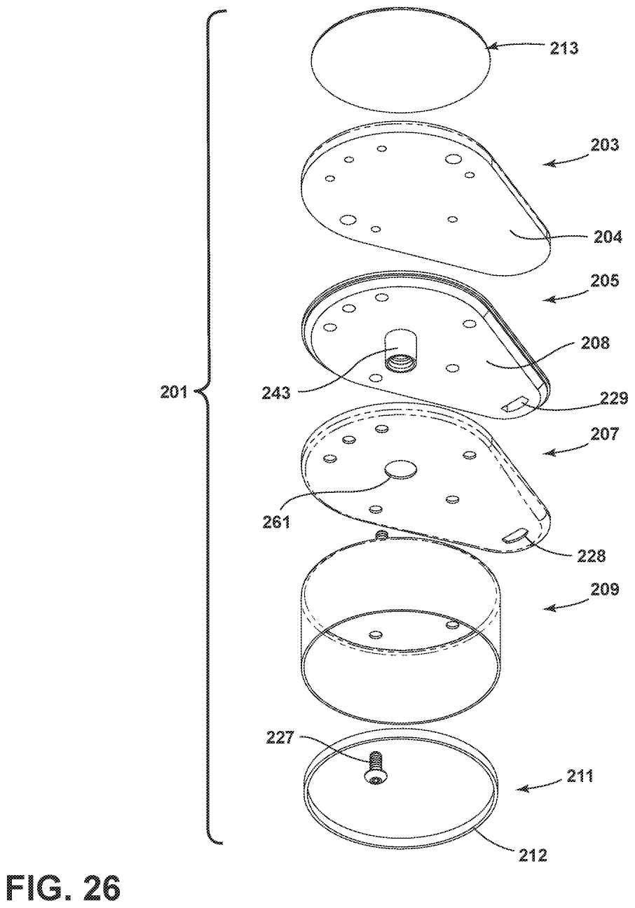

FIGS. 25 and 26 illustrate an alternative pump top construction. The pump top 201 of FIG. 25 includes a top half 203, a bottom half, 207, and a flexible silicone rubber or flexible plastic insert 205 positioned between the top and bottom halves 203, 207 to provide a liquid flow path within the pump top 201. The pump top 201 further includes a hollow cylindrical ring or cup 209, a circular plastic (low friction) protector 211, and a circular medallion 213. In the illustrative embodiment, the rear perimeter of each of the top and bottom halves 203, 207 and the rear perimeter of the silicon rubber or a flexible plastic insert 205 each follow the same semicircular contour with a radius which matches that of the cylindrical cup 209.

In an illustrative embodiment, the top half 203 may be formed of a suitable metal, for example, stainless steel, and in one embodiment may be a solid cast metal part. In one embodiment, the circular medallion 213 is a solid disc, again formed of a suitable metal or plastic, for example, stainless steel. In an illustrative embodiment, the bottom half 207 and the cylindrical cup 209 may also be formed of a suitable metal such as stainless steel. The top half 203, bottom half 205, cylindrical cup 207 and medallion 213 may of course be formed of different materials and by various different fabrication methods in various other embodiments.

In one illustrative embodiment, the silicone rubber insert 205 is seated within an inner rim 224 of the lower pump top half 207 and is sandwiched between the top half 203 and bottom half 207 and concealed from view by those components 203, 207. As seen in FIG. 25, the insert 205 provides a liquid guide or channel 271 formed by an outer vertical side surface 273 and an inner vertical side surface 275. The liquid guide 271 guides liquid to be dispensed from a liquid inlet port 241 to a liquid outlet port 229 (FIG. 26). In the illustrative embodiment, raised rubber ridges 274, 276 are formed around the channel 271 and, when compressed during attachment of the bottom half 207 to the top half 203, form a liquid seal around the flow path between the ridges 274, 276 and the flat bottom surface 204 (FIG. 26) of the top-half component 203.

As seen in FIG. 26, the silicone rubber insert 205 further includes a cylindrical pump stem receptacle 243 depending from a bottom surface 208 thereof, which passes through respective circular openings, 261, 263 in the bottom half 207 and the cylindrical cup 209. In an illustrative embodiment, the insert 205 may be a molded part. In other embodiments, the insert 205 may be formed of other materials, for example, such as a suitable plastic or composite. In illustrative silicone rubber embodiments, the hardness of the silicone rubber may be 25 to 85 Shore A.

The top half 203 of the pump top 201 further includes first and second holes 284, 286 which cooperate with cylindrical projection 280 and a squared-off projection 282 formed on the silicone rubber insert 205 to position the top 203 of the pump head 201 radially relative to the insert 205. These features prevent potential minor misalignments of the positions of the screw holes in the respective parts 203, 205, which could cause a small visual misalignment of the top half 203. Thus, the fully rounded feature 280 locates the part 203, and the squared-off rounded feature 282 locks it in place.

In the illustrative embodiment of FIGS. 25 and 26, to assemble the pump top 201, screws or other fastening devices 233, 214, 215, 227 are passed through the cylindrical cup 209, through respective aligned holes 217; 219, 222, 254 in the bottom half 207, then through respective aligned holes 218, 221, 223; 255 in the insert 205, and then into respective threaded holes 224, 225, 226, 269 in the top half 203. The plastic guide protector 211 is then attached to the cup 209 by a press-fit or suitable bonding adhesive, and the medallion 213 is attached in place, e.g. by a suitable adhesive, so as to cover the holes, e.g. 224, 225, 226, 269, 245, 247, 284, 286 in the top half 203.

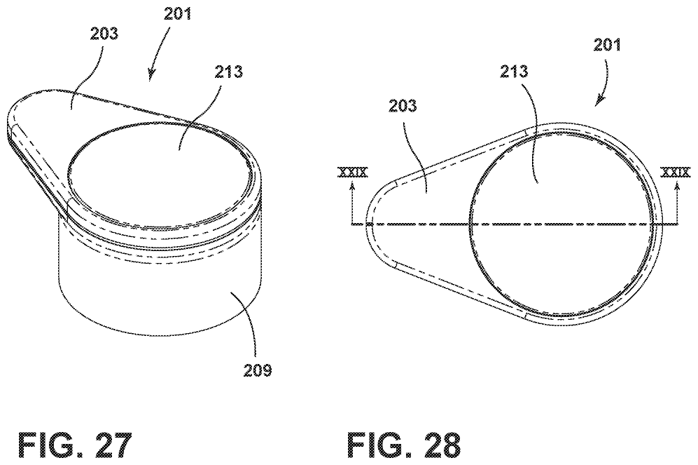

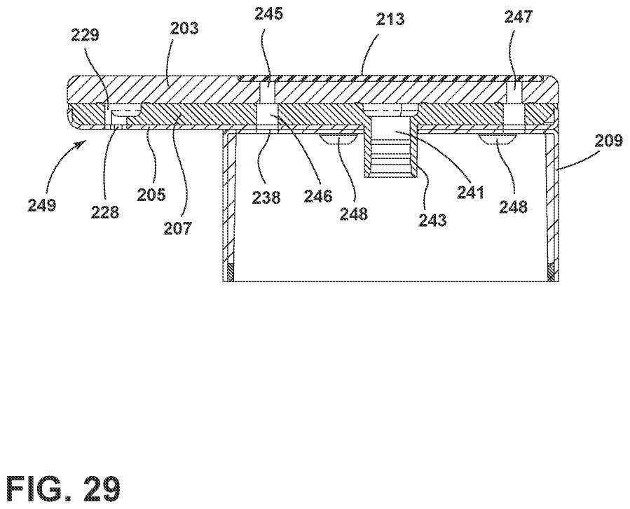

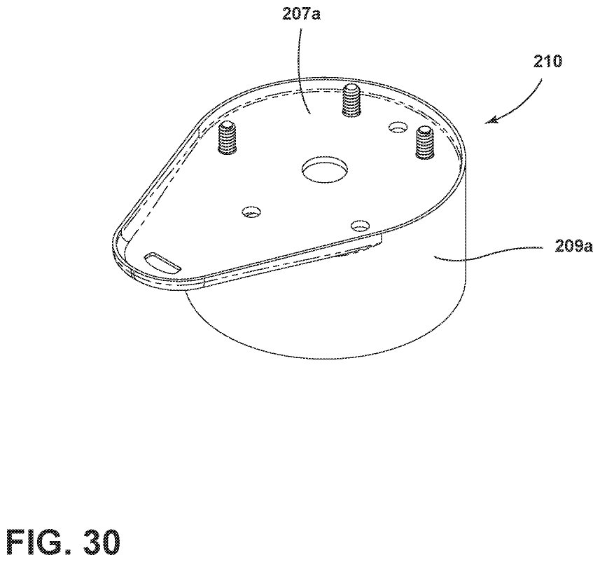

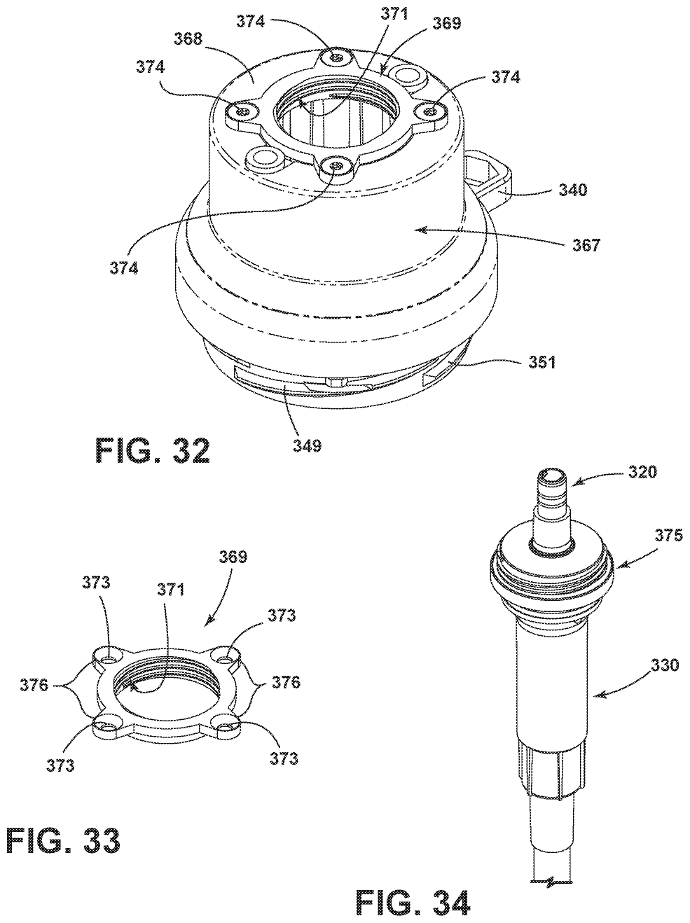

FIGS. 27 and 28 illustrate the assembled pump top 201. The sectional view of FIG. 30 particularly illustrates the fluid inlet port 241 positioned above the cylindrical pump stem receptacle 243, which is suitably threaded or otherwise configured to receive and attach a pump stem, e.g., 320 shown in FIG. 34. In the illustrative embodiment, the inlet port 243 is formed as part of the silicon rubber insert 207. A fluid outlet port 249 is formed by respective openings 228, 229 in the bottom pump top half 205 and the silicon rubber insert 207. First and second bumps 248 are stamped or formed into the metal cup bottom surface and act as a stop to prevent the pump top motion from bottoming out on the external top surface of the shroud 368 (FIG. 32) by restricting the travel a small amount at its maximum. Openings 245, 247 receive respective guide pins configured similarly to guide pins 163, 161 of FIG. 24

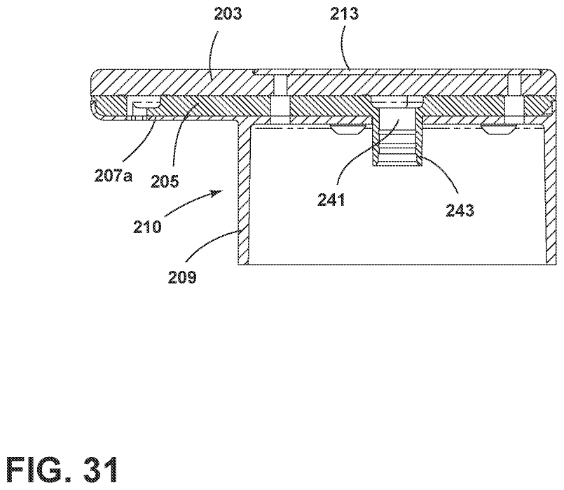

FIGS. 30 and 31 illustrate an alternate embodiment wherein a bottom half 207a and cylindrical cup 209a are formed as a single cast metal component 210. In this embodiment, the bottom half 207a provides the same interface with the insert 205 as the bottom half 205 of FIGS. 25 and 26.

FIGS. 32-34 illustrate an alternative structure for attaching a liquid pump 330 to a pump shroud and closure assembly 367. In this embodiment, a ring component 369 has a threaded circular interior 371 and four threaded screw holes 373 formed in respective flanges 376 spaced ninety degrees apart around the outer perimeter of the ring 369.

As shown in FIG. 32, the ring component 369 is attached to the shroud and closure assembly 367 by respective screws 374. A liquid pump 330 may then be threaded up into the threaded interior of the ring component 369 to thereby install the pump 330 into position in the assembly 367. Such an alternate pump attachment structure may be adapted for use with various closure structures employed to close an open end of a canister, for example, such illustrated herein, or such as illustrated in FIGS. 54-58 of U.S. Pat. No. 11,332,279.

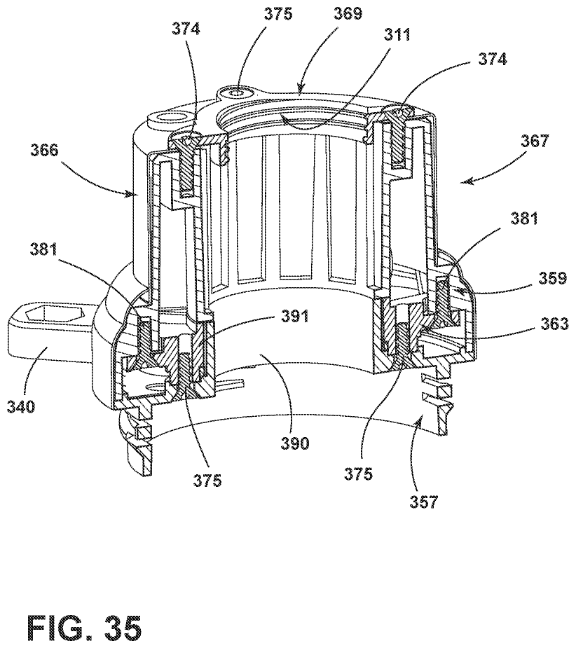

FIG. 35 further illustrates the pump top and closure assembly 367. As shown, this assembly includes a lower closure component 357, an alignment disc 363, and an upper closure component 359. The lower component 357 includes a circular vertically disposed inner rim 390 which inter-fits with or plugs into a circular vertical inner rim of an inner edge 391 of the alignment disc 363. Screws 375 attach the lower closure component 357 to the alignment disc 363, and screws 381 attach the alignment disc 363 to the upper closure component 359. The lower closure assembly is again threaded to mate via threads in the lower component 357 with an adapter ring such as adapter ring 27 disclosed in FIG. 4. Thus, the closure assembly of FIG. 35 is generally similar to that of FIG. 6 with the exception that no circuit board is mounted therein.

From the foregoing, those skilled in the art will appreciate that various adaptations and modifications of the just described illustrative embodiments can be configured without departing from the scope and spirit of the invention. For example, in various illustrative embodiments, for corrosion resistance, metallic parts may either be stainless steel, anodized, lacquered, and/or powder coated. Therefore, it is to be understood that, within the scope of the appended claims, the invention may be practiced other than as specifically described herein.

What is claimed is:

1. A pump top for a liquid dispenser comprising:
a top half, a bottom half, a flexible insert positioned between the top and bottom halves, and a cylindrical cup attached to an underside of the bottom half;
wherein the flexible insert comprises a liquid guide formed to lie beneath a bottom surface of the top half, the liquid guide being formed by an inner vertical side surface and an outer vertical side surface, the liquid guide being configured to form a liquid flow path to conduct liquid to be dispensed from a liquid inlet port formed in the flexible insert to a liquid outlet port formed in the flexible insert; and
wherein the flexible insert further comprises first and second raised flexible ridges formed around the liquid guide and configured such that when the top and bottom halves are attached together, the flexible insert is compressed and the first and second raised ridges form a liquid seal around the liquid flow path provided by the liquid guide.

2. The pump top of claim 1 further comprising a circular plastic protector attached to a bottom end of the cylindrical cup.

3. The pump top of claim 1 wherein a respective rear perimeter of each of the top half, the bottom half, and the flexible inset each follow the same semicircular contour, said contour having a radius which matches a radius of the cylindrical cup.

4. The pump top of claim 1 wherein the flexible insert is sandwiched between the top half and bottom halves and concealed from view by those two components.

5. The pump top of claim 1 wherein the flexible insert is formed of silicone rubber.

6. The pump top of claim 1 wherein the cylindrical cup and the bottom half are formed as a single cast metal part.

7. A pump top for a liquid dispenser comprising:
a top half, a bottom half, a flexible insert positioned between the top and bottom halves, and a cylindrical cup attached to an underside of the bottom half; and
wherein the flexible insert comprises a liquid guide formed to lie beneath a bottom surface of the top half, the liquid guide being formed by an inner vertical side surface and an outer vertical side surface, the liquid guide being configured to provide a liquid flow path to conduct liquid to be dispensed from a liquid inlet port formed in the flexible insert to a liquid outlet port formed in the flexible insert.

8. The pump top of claim 7 further comprising a circular plastic protector attached to a bottom end of the cylindrical cup.

9. The pump top of claim 7 wherein a respective rear perimeter of each of the top half, the bottom half, and the flexible inset each follow the same semicircular contour, said contour having a radius which matches a radius of the cylindrical cup.

10. The pump top of claim 7 wherein the flexible insert is sandwiched between the top half and bottom halves and concealed from view by those two components.

11. The pump top of claim 7 wherein the flexible insert is formed of silicone rubber.

12. The pump top of claim 7 wherein the cylindrical cup and the bottom half are formed as a single cast metal part.
